(19) United States
(12) Patent Application Publication
(10) Pub. No.: US 2023/0281308 A1
(43) Pub. Date: Sep. 7, 2023

(54) SYSTEMS, METHODS, AND DEVICES FOR EXECUTABLE FILE CLASSIFICATION

(71) Applicant: Sentinel Labs Israel Ltd., Tel Aviv (IL)

(72) Inventors: Tal Maimon, Rishon LeZion (IL); Roy Ben Shlomo, Kochav Yair (IL)

(21) Appl. No.: 18/176,759

(22) Filed: Mar. 1, 2023

Related U.S. Application Data
(60) Provisional application No. 63/315,827, filed on Mar. 2, 2022.

(51) Int. Cl. G06F 21/56; G06F 8/65

(52) U.S. Cl. CPC G06F 21/563; G06F 8/66

(57) ABSTRACT

Methods according to the embodiments herein may include generating, by a computer system using a decompiler, assembly code from a binary file. The methods may comprise identifying, by the computer system using one or more heuristics, one or more functions in the assembly code. The methods may comprise identifying, by the computer system, one or more code blocks within the one or more functions in the assembly code. The methods may comprise determining, by the computer system, one or more execution paths through the one or more code blocks. The methods may comprise generating, by the computer system, one or more sentences representing execution paths through the one or more code blocks, wherein generating the one or more sentences comprises performing one or more random walks through one or more execution paths.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

This application claims the benefit of U.S. Provisional Application No. 63/315,827, entitled “SYSTEMS, METHODS, AND DEVICES FOR EXECUTABLE FILE CLASSIFICATION,” filed Mar. 2, 2023, the contents of which are incorporated by reference herein in their entirety.

### BACKGROUND

### Field

The embodiments herein are generally related systems, methods, and devices for generating representations of executable files.

### Description

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Identifying malicious files (e.g., viruses, worms, Trojan horses, ransomware, spyware, adware, keyloggers, and so forth) is an ongoing problem in computing. However, current approaches have significant limitations that may cause them to misclassify executable files.

### SUMMARY

For purposes of this summary, certain aspects, advantages, and novel features of the invention are described herein. It is to be understood that not all such advantages necessarily may be achieved in accordance with any particular embodiment of the invention. Thus, for example, those skilled in the art will recognize that the invention may be embodied or carried out in a manner that achieves one advantage or group of advantages as taught herein without necessarily achieving other advantages as may be taught or suggested herein.

Some embodiments herein relate to a method for generating representations of an executable file comprising: generating, by a computer system using a decompiler, assembly code from the executable file; identifying, by the computer system using one or more heuristics, one or more functions in the assembly code; identifying, by the computer system, one or more code blocks within the one or more functions in the assembly code; determining, by the computer system, one or more execution paths through the one or more code blocks; and generating, by the computer system, one or more representations of the executable file representing execution paths through the one or more code blocks, wherein generating the one or more representations of the executable file comprises performing one or more random walks through one or more execution paths.

In some aspects, the techniques described herein relate to a computer-implemented method for binary file analysis including: receiving, by a computer system, a binary file, wherein the binary file includes executable code; generating, by the computer system using a decompiler, assembly code from the binary file, wherein the assembly code includes a sequence of instructions that can be executed on an other computing system; identifying, by the computer system using one or more heuristics, one or more functions in the assembly code, wherein each function of the one or more functions includes one or more instructions; identifying, by the computer system, one or more blocks within the one or more functions in the assembly code, wherein each block of the one or more blocks includes one or more instructions; generating, by the computer system, a directed graph, wherein the directed graph includes possible execution paths through the one or more blocks; determining, by the computer system using the directed graph, one or more execution paths through the one or more code blocks, wherein determining the one or more execution paths includes performing a random walk through the directed graph; generating, by the computer system, one or more sentences representing the one or more execution paths through the one or more code blocks; determining, by the computing system using a language model, a vector representation for each sentence of the one or more sentences, wherein the computer system includes a processor and memory.

In some aspects, the techniques described herein relate to a method, further including: determining, by the computing system using vector representations, a classification of the binary file, wherein the classification indicates that the file is malicious or that the file is not malicious.

In some aspects, the techniques described herein relate to a method, wherein generating the one or more sentences includes: determining that a sentence of the one or more sentence is the same as another sentence of the one or more sentences; and deleting the sentence.

In some aspects, the techniques described herein relate to a method, wherein generating the one or more sentences includes: determining that a sentence includes a sequence of adjacent instructions, wherein each instruction in the sequence of adjacent instructions is the same; and removing repeated instructions from the sequence of adjacent instructions.

In some aspects, the techniques described herein relate to a method, wherein identifying one or more functions in the assembly code includes identifying a stack frame.

In some aspects, the techniques described herein relate to a method, wherein identifying the one or more functions in the assembly code includes determining a target address of a call instruction.

In some aspects, the techniques described herein relate to a method, wherein identifying the one or more code blocks includes identifying a branching instruction.

In some aspects, the techniques described herein relate to a method, wherein the branching instruction includes a jump instruction.

In some aspects, the techniques described herein relate to a method, wherein identifying the one or more code blocks includes identifying an address of a call instruction.

In some aspects, the techniques described herein relate to a method, further including: determining, by the computing system using the vector representation, a clustering of the binary file, wherein the clustering indicates a similarity of the binary file to a second binary file.

In some aspects, the techniques described herein relate to a computing system including for binary file analysis including: a non-transitory computer-readable storage medium with instructions encoded thereon; and one or more processors, wherein the instructions, when executed by the one or more processors, cause the computing system to: receive a binary file, wherein the binary file includes executable code; generate, using a decompiler, assembly code from the binary file, wherein the assembly code includes a sequence of instructions that can be executed on an other computing system; identify, using one or more heuristics, one or more functions in the assembly code, wherein each function of the one or more functions includes one or more instructions; identify one or more blocks within the one or more functions in the assembly code, wherein each block of the one or more blocks includes one or more instructions; generate a directed graph, wherein the directed graph includes possible execution paths through the one or more blocks; determine, using the directed graph, one or more execution paths through the one or more code blocks, wherein determining the one or more execution paths includes performing a random walk through the directed graph; generate one or more sentences representing the one or more execution paths through the one or more code blocks; determine, using a language model, a vector representation for each sentence of the one or more sentences.

In some aspects, the techniques described herein relate to a computing system, wherein the instructions are further configured to cause the computing system to: determine, using vector representations, a classification of the binary file, wherein the classification indicates that the file is malicious or that the file is not malicious.

In some aspects, the techniques described herein relate to a computing system, wherein to generate the one or more sentences, the instructions are configured to cause the computing system to: determine that a sentence of the one or more sentence is the same as another sentence of the one or more sentences; and delete the sentence.

In some aspects, the techniques described herein relate to a computing system, wherein to generate the one or more sentences, the instructions are configured to cause the computing system to: determine that a sentence includes a sequence of adjacent instructions, wherein each instruction in the sequence of adjacent instructions is the same; and remove repeated instructions from the sequence of adjacent instructions.

In some aspects, the techniques described herein relate to a computing system, wherein to identify one or more functions in the assembly code, the instructions are configured to cause the computing system to identify a stack frame.

In some aspects, the techniques described herein relate to a computing system, wherein to identify the one or more functions in the assembly code, the instructions are configured to cause the computing system to determine a target address of a call instruction.

In some aspects, the techniques described herein relate to a computing system, wherein to identify the one or more code blocks, the instructions are configured to cause the computing system to identify a branching instruction.

In some aspects, the techniques described herein relate to a computing system, wherein the branching instruction includes a jump instruction.

In some aspects, the techniques described herein relate to a computing system, wherein to identify the one or more code blocks, the instructions are configured to cause the computing system to identify an address of a call instruction.

In some aspects, the techniques described herein relate to a computing system, wherein the instructions are further configured to cause the computing system to: determine, using the vector representation, a clustering of the binary file, wherein the clustering indicates a similarity of the binary file to a second binary file.

Various combinations of the above and below recited features, embodiments, and aspects are also disclosed and contemplated by the present disclosure.

Additional embodiments of the disclosure are described below in reference to the appended claims, which may serve as an additional summary of the disclosure.

### BRIEF DESCRIPTION OF THE DRAWINGS

The drawings are provided to illustrate example embodiments and are not intended to limit the scope of the disclosure. A better understanding of the systems and methods described herein will be appreciated upon reference to the following description in conjunction with the accompanying drawings, wherein:

FIG. 1 illustrates an example flowchart of a process for generating sentences according to some embodiments herein.

FIG. 2 is a block diagram illustrating an example computer process for training a machine learning model according to some embodiments herein.

FIG. 3 illustrates an example process for determining whether a binary file contains malware according to some embodiments herein.

FIG. 4 illustrates an example process for determining whether a binary file contains malware according to some embodiments herein.

FIG. 5 is an example of a graphical representation of clustering and classification according to some embodiments herein.

FIG. 6 illustrates an example process for clustering binary files according to some embodiments herein.

FIG. 7 is a block diagram depicting an embodiment of a computer hardware system configured to run software for implementing one or more embodiments disclosed herein.

### DETAILED DESCRIPTION

Although certain preferred embodiments and examples are disclosed below, inventive subject matter extends beyond the specifically disclosed embodiments to other alternative embodiments and/or uses and to modifications and equivalents thereof. Thus, the scope of the claims appended hereto is not limited by the embodiments described below. For example, in any method or process disclosed herein, the acts or operations of the method or process may be performed in any suitable sequence and are not necessarily limited to any disclosed sequence. Various operations may be described as multiple discrete operations in turn, in a manner that may clarify certain embodiments; however, the order of description should not be construed to imply that these operations are order dependent. Additionally, the structures, systems, and/or devices described herein may be embodied as integrated components or as separate components. For purposes of comparing various embodiments, certain aspects and advantages of these embodiments are described. Not necessarily all such aspects or advantages are achieved by any embodiment. Thus, for example, various embodiments may be carried out in a manner that achieves one advantage or group of advantages as taught herein without necessarily achieving other aspects or advantages as may also be taught or suggested herein.

Certain example embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting example embodiments and that the scope of the present invention is defined solely by the claims. The features illustrated or described in connection with one example embodiment may be combined with the features of other embodiments. Such modifications and variations are intended to be included within the scope of the present technology.

Determining whether or not binary files (“binaries”) or other types of executable files contain malicious functionality is an important problem in computer and network security. Various systems and methods currently exist to classify files as malicious or not malicious. A file that is classified as malicious by a classification system and later verified as malicious may be termed a true positive classification, while a file that is classified as malicious and later verified as benign may be termed a false positive classification. Similarly, there can be true negatives (e.g., non-malicious files that are classified as non-malicious) and false negatives (e.g., malicious files that are incorrectly identified as non-malicious). It is important that classification systems maximize the true positive and true negative rates while minimizing the false positive and false negative rates, because while missing actual malware may allow computer systems or networks to become infected or compromised, too many false positives may cause users to ignore warnings or to stop using the classification systems altogether.

Often, various malicious executable files may carry similar static signatures because, for example, many such malicious executable files may share common malicious code. Some classification systems may ascertain whether a file is malicious or not by analyzing properties of the file without executing the file. File signatures may be determined, for example, by examining various contents of the file, such as, for example, strings, headers, signatures, etc., in an executable file. In some cases, the operations that may be performed by the executable file may be determined, for example, by using a decompiler. In some instances, a machine learning (ML) or artificial intelligence (AI) algorithm may be used to determine a probability that a file is malicious or benign by examining static features. However, such approaches are limited and may lead to the misclassification of files. For example, a malicious binary file and a benign binary file may perform many similar functions such as writing, modifying, and/or deleting files, downloading and/or uploading information over a network, and the like, potentially causing false positives. On the other hand, even small modifications to malicious code could significantly change the signatures of the code, resulting in false negatives.

There can be significant limitations to current malware identification approaches, which can lead to relatively high levels of false positives and/or false negatives. Dynamic analysis approaches can more accurately reflect execution paths, but it can be infeasible to perform sufficient numbers of executions to fully (or substantially fully) reflect the possible execution paths, which can reduce reliability. Conventional static analysis methods can fail to consider possible execution paths. Thus, there is a need for static analysis methods for identifying malware that distinguish between malicious and benign executable files that perform similar functions and that recognize similarities in malicious binaries even if code therein has been modified to evade detection.

Some embodiments herein relate to the classification of binary files for purposes of detecting viruses, spyware, Trojan horses, ransomware, and other malicious software (collectively referred to herein as “malware” or “malicious software”), and/or to the attribution of malware. Classification and attribution can be important for users of malware detection software for many reasons. For example, a customer may want to determine whether it has been subject to a targeted attack or if malware was simply downloaded by a careless employee. Knowing whether two files are the same, are from a common family, or are from a common author, regardless of whether they are malicious or not, allows a higher dimension of decision making (for example, commonality might indicate a targeted attack) but also requires a higher dimension of information than identifying files as malicious or not. The systems and methods described herein can provide for classification and attribution based at least in part on representations of the intrinsic nature of executable files. Executable files may be grouped into families and attributed to particular attackers or groups.

In some embodiments, the systems and methods herein may organize computer operations in a similar way as natural language processing, likening sequences of operations to natural language sentences. Just as there are multiple ways to express similar ideas in natural language, there are often multiple ways to carry out similar tasks in computer code. Additionally, just as there are relations between ideas in natural language, there are often relations between ideas in computer languages. For example, writing data to a screen and writing data to a file are similar concepts in computer code.

In some embodiments, AI/ML models may be used on executable code in a similar way that AI/ML is used to carry out various natural language tasks. For example, language models may be used in natural language processing tasks such as speech recognition, machine translation, word prediction, and sentiment analysis. To accomplish these tasks, natural language data may be preprocessed by, for example, removing duplicates, deleting words with lesser importance (e.g., “a” or “is”), and identifying features of interest in the data (e.g., gender or color). Language models convert natural language into mathematical vector representations that may indicate relationships between words or phrases and the features. Vectors may be tailored for particular tasks such as disambiguating words with multiple meanings, determining sentiment, predicting the next word or words in a sentence, and so forth. For example, a language model may be trained to solve analogies by looking at semantic relationships between words. For example, a model may determine vectors representing the words King, Queen, Man, and Woman. The model may solve the analogy “Man is to King as Woman is to ______” by performing a mathematical calculation on the vectors representing each word to arrive at a solution to the analogy, in this example King−Man+Woman=Queen. Solving such analogies using a language model requires that the vectors determined by the model have a strong correspondence to the semantic relationships between words.

Similarly, according to some systems and methods described herein, a natural language model may be applied to analyze computer code. In some embodiments, a language model may determine vector representations that can be used to identify relationships between binary files. If properly trained, the vector representations produced by the model may be used to help identify whether a particular binary file is malicious. In some embodiments, the language model may be trained using a corpus that represents binary files. However, there are many difficulties in generating a suitable corpus for training a language model to recognize similarities and differences in binary files.

### Corpus Construction

While some embodiments herein may utilize language models to detect malicious files, existing language models are not capable of interpreting binary files. In some embodiments, one solution is to construct a custom working language model for binary files, but this is a labor-intensive and time-consuming process. Thus, in some embodiments, an existing language model may be utilized, but instead of applying the language model directly to the code, the binary files may first be manipulated into a form that can be understood by the language model.

In some embodiments, the binary files may be processed to create a corpus of sentences that represent the binary files. An existing language model may then be trained to classify binaries as malicious or benign using the generated corpus of sentences. In some embodiments, the language model may not itself classify files. For example, the outputs of the language model (e.g., vectors) can be fed into a classification model (also referred to herein as a classification head) which can be configured to determine if the binary is malicious or benign. In some embodiments, the language model may generate vectors, which may further be used to determine the lineage and/or authorship of binaries, either in addition to or alternatively to determining if a file is malicious or benign. That is, the vectors may facilitate clustering of binary files into groups that share common functionality or that appear to be created by a common author.

In some embodiments, constructing a corpus of sentences from binary files may involve considerable complexity. In some embodiments, the system may build a corpus by analyzing a plurality of binary files in a dataset. In some embodiments, the plurality of binary files may comprise thousands or even millions of samples of known malicious and benign binary files. In some embodiments, the system may learn representations of functions and/or sequences of functions that may be executed by the samples in the dataset.

In some embodiments, the binary files may be characterized by dynamically determining the possible sequences of functions that a binary file may execute. That is, a binary file could be executed multiple times with different parameters and/or on systems with different configurations (e.g., in a virtual machine, using processors or other hardware from different manufacturers, using different operating system versions or patch levels, etc.) to determine which functions are executed and in what sequences. This approach, however, may be infeasible for a number of reasons. For example, a malicious binary file may follow different execution paths (e.g., execute different functions, different branches of conditional statements, and so forth) depending upon the inputs provided to the binary file, the operating system the binary file is running on, the hardware (or virtual machine) used to run the binary file, the patches (or patch versions) applied to the operating system or to other software installed on the system, the other software that has been installed on the system, the other software running on the system at execution (e.g., the behavior of the binary file may be different if the binary file detects that some type of monitoring software (e.g., antivirus, anti-malware, corporate monitoring software, etc.) is in use), and whether the system is joined to a domain, among others. Thus, an infeasible number of runs on an infeasible number of test environments may be needed to adequately characterize the behavior of every binary file in the dataset. Alternatively, in some embodiments, a limited number of runs may be used, but this method may significantly limit the robustness of the characterization of the files. For example, some execution paths may be missed.

In some embodiments, rather than dynamic analysis, static analysis may be used to determine the possible sequences of functions for each binary file in the dataset. Using static analysis, it is possible to extract multiple possible sequences of instructions or functions without executing each binary file multiple times (or even once). In some embodiments, static analysis may significantly increase the number of possible sequences that can be determined in a given timeframe and may eliminate the need to set up multiple test environments. Preferably, the results of static analysis should represent execution paths that might actually be performed if a binary file is executed. The systems and methods described herein can enable determination of possible execution paths by analyzing disassembled or decompiled code.

In some embodiments, a system may be configured to create a corpus by disassembling each binary file in a dataset to create sets of assembly language instructions. Disassembling each binary file may be accomplished using custom-made software or using commonly available disassembly tools. The disassembly process may include parsing a symbol table that includes function addresses and names, parsing an import directory table that includes each imported library, or both.

The disassembly process can result in a sequence of code that lacks much of the structure, such as functions, that may have been present in the original source code, which can make analysis more difficult. After disassembly, the system may be configured to identify functions in the assembly instructions. This process can be imprecise because assembly language lacks concrete identifiers of where functions begin and end. However, the system may use various heuristics to identify functions. For example, the system may look for indications in the assembly language instructions that mark the beginning or end of a function, such as common prefixes or suffixes. As one example, for programs written in high level languages (such as, e.g., C++), a compiler will often set up a stack frame at the start of a function. The system may detect a stack frame in the assembly language instructions and identify the stack frame as the likely start of a function. Other heuristics may be used additionally or alternatively to identify the different functions in the assembly language instructions. For example, a system may identify one, some, or all of the “call” instructions and their target addresses, which may indicate that a target address could be a function.

A system may be configured to create a directed graph representation of each function in the assembly language instructions by dividing each function into code blocks and identifying the possible relations between code blocks. For example, each node in the directed graph may be a code block which may consist of multiple instructions and may include calls to other code blocks or functions (or, in the case of a recursive function, to itself). In some embodiments, the end of a code block may be determined by various heuristics such as, for example, the presence of a jump instruction or other type of branching instruction. For example, in x86 assembly, the presence of a “jz” instruction, which may be used to specify a conditional jump, may indicate the end of a code block. In some cases, the blocks identified by the system may correspond to blocks in the original source code of the program. In other cases, such as when a block in the original source code contains a jump instruction, the system may split the original block into two blocks. In some embodiments, code blocks may be connected to each other in the graph if the assembly code indicates that it is possible to get from one code block to another code block. The connections between code blocks are directed because, for example, it may be possible to traverse from a first code block to a second code block, but not from the second code block to the first code block.

While the above discussion refers to x86 assembly, this is done solely for illustrative purposes. Similar approaches can be used for other architectures such as, for example, ARM, Power, RISC-V, and/or other instruction set architectures with appropriate modifications to account for differences in naming conventions for instructions, differences in the behavior of instructions, and so forth.

In some embodiments, the system may construct sentences from the directed graph, the sentences representing possible execution paths. In some embodiments, the sentences may be constructed by performing random walks through the directed graphs of each function. For example, a sentence may be constructed by moving from a first node on the directed graph to another connected node on the directed graph, and this may be repeated for a fixed number of steps (e.g., a fixed number of nodes), until there are no more possible steps, or for a number of steps that is determined dynamically (e.g., based on the number of possible random walks). In some embodiments, by randomly walking through a directed graph multiple times, the system may mimic the operation of running a function without ever actually executing the function. At each node (code block) in the directed graph, the system may extract all of the functions that were called in that node. In some embodiments, by performing multiple random walks, the system may generate a representative sample of sequences that could occur in actual execution. In some embodiments, the system may limit the number of random walks. For example, the system may perform about 10, about 20, about 30, about 40, about 50, about 100, about 1,000, about 10,000, about 100,000, about 1,000,000, or about 10,000,000 random walks, or any number between the aforementioned values, or even more if needed or desired. In some embodiments, the number of runs can be adjusted based on, for example, the size of the code block, the number of paths that lead to the code block, and so forth.

It will be appreciated that the approach described above can also be applied to whole executables. For example, possible paths including multiple functions can be determined and analyzed. In some embodiments, a system can be configured to determine a map of relationships between functions. In some embodiments, the system can be configured to also map relationships between blocks within functions. In some embodiments, it can be desirable to analyze at the function level without analyzing the blocks within each function, for example to speed up analysis times.

In some embodiments, the system may detect one or more issues such as infinitely recursive function calls or that two different walks produce the same behavior. In some embodiments, the system may be configured to de-duplicate the resulting sentences or may stop processing certain walks. As just one example, two sentences may be identified as duplicates if one calls the “print” function five times and the other calls the “print” function ten times, but the two sentences are otherwise identical.

The system may, after performing the random walks, output multiple sentences that represent sequences that could run. For example, a sentence for reading a file and printing parts of it to the screen might be “snprintf fopen getdelim sscan free getdelim puts printf puts free exit.” Other sentences might indicate that a possible sequence is to open a file, write to the file, and then exit, for example. A large number of sentences may be generated for each binary file in the dataset, reflecting the possibly large number of execution paths a binary file could follow.

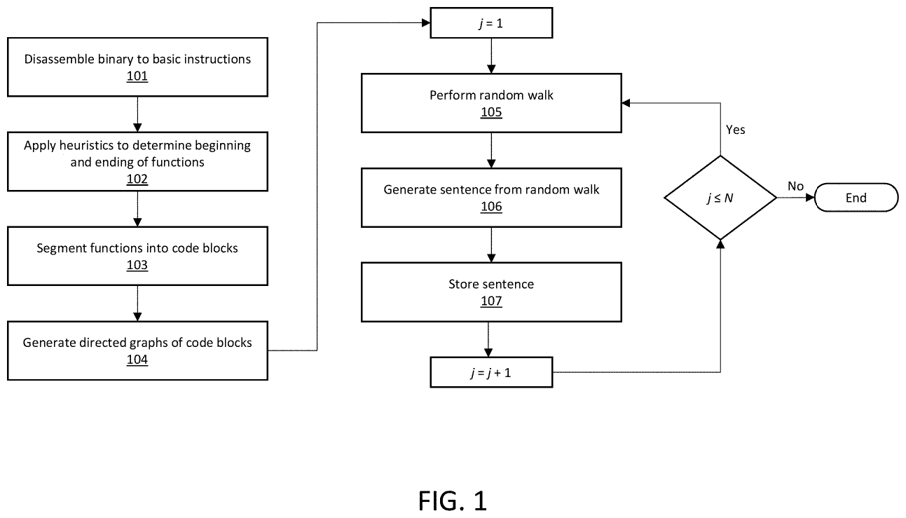

FIG. 1 illustrates an example flowchart of a process for generating sentences according to some embodiments herein. At block 101, the system may disassemble a binary into basic instructions (for example, assembly instructions). At block 102, the system may apply one or more heuristics to the disassembled basic instructions to determine functions within the basic instructions. At block 103, the system may segment each determined function into one or more code blocks. At block 104, the system may generate directed graphs that indicate how the code blocks relate to each other (e.g., identify the possible execution paths). The system may initialize a counter j for counting a number of random walks. The system may, at block 105, perform a random walk through a possible execution path to, at block 106, generate a sentence representing the execution path. The generated sentence may be stored at block 107 for future use in training a language model. In some embodiments, the counter j may be incremented until blocks 105, 106, and 107 have been performed N times for each function in the library. For example, blocks 105, 106, and 107 may be repeated about 10, about 20, about 30, about 40, about 50, about 100, about 1,000, about 10,000, about 100,000, about 1,000,000, about 10,000,000 times, or any number between the aforementioned values, or even more if needed. In some embodiments, the number of runs may be determined at least in part by the number of code blocks in the function and may vary from function to function. For example, if a function doesn't contain any conditional statements and only one execution path is possible, there may not be a need to walk through the function more than once. Likewise, for a complex function with many possible execution paths, it may be advantageous to perform a greater number of walks through the function.

In some embodiments, a large number of binary files may be run through the process depicted in FIG. 1 (or a similar process) to generate a plurality of sentences that represent the various execution paths that the binary files can follow, thereby creating a corpus of sentences that represent possible execution paths for the binaries.

It will be appreciated by one skilled in the art that while the process for generating a corpus was explained above in terms of assembly code, functions, and code blocks, a similar approach could be employed using bytecode or p-code, intermediate representations produced by a decompiler, or high-level source code produced by a decompiler. In some embodiments, similar ideas may be applied to interpreted code. For interpreted code, the disassembly, function identification, and function segmentation steps could be skipped or significantly simplified because the original source code is available, so there is no need to reconstruct it from a binary representation. Different units or groupings of code could be used for analysis. It will be understood that different choices may have different advantages and disadvantages. For example, a corpus may be faster to generate using one approach but may ultimately lead to a lesser classification ability.

### Language Model Training

The corpus can be used to train a language model which may be a purpose-built model or an existing language model such as, for example, a model provided by the open-source Hugging Face Transformers library such as BERT, GPT, GPT-2, Transformer-XL, XLNet, XLM, RoBERTa, or DistilBERT. In some embodiments, the trained language model may be used to generate vector representations of the sentences. These vector representations may be used in a variety of applications. For example, the vectors may be provided to an additional model to determine if a binary file contains malware, uses a particular library version, or shares a common author with another binary file, among other applications.

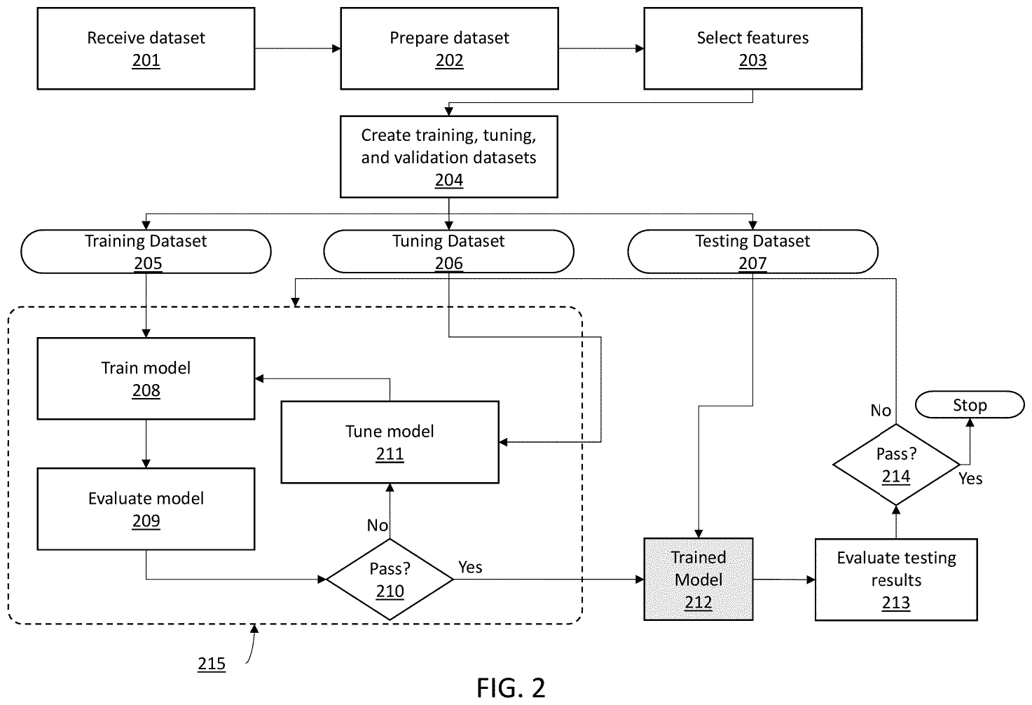

FIG. 2 is a block diagram illustrating an example computer process for training a machine learning model according to some embodiments herein. The example process of FIG. 2 can be used to train, for example, a language model, a classification head, and/or a clustering head. The proceeding description describes training a language model, but it will be understood that the same or a similar process can be used for training other models. At block 201, the system may receive a dataset such as a corpus of sentences generated by, for example, the process illustrated in FIG. 1. At block 202, one or more steps may be performed to prepare the dataset such as, for example, removing duplicates, adding, or modifying metadata, among others. In some embodiments, data may under relatively minor transformations such as data normalization steps to prepare the data for training. in some cases, however, more significant transformations can be performed. For example, a system can be configured to simplify sentences, for example by deleting multiple instances of the same command when they appear adjacent to one another. For example, a block with a code portion that calls “print print print” can have that code portion simplified to “print.” At block 203, the system may receive one or more features of interest from the dataset. For example, the system may be trained to differentiate between malicious and benign files. At block 204, the system may create, from the received dataset, training, tuning, and testing datasets. The training dataset 205 may be used during training to determine variables for forming a predictive model. The tuning dataset 206 may be used to select final models and to prevent or limit overfitting that may occur when, during training, relationships are identified in the training dataset 205 that do not generally hold true. The testing dataset 207 may be used after training and tuning to evaluate the model. For example, the testing dataset 207 may be used to check if the model is overfitted to the training dataset. The system, in training loop 215, may train the model at 208 using the training dataset 205. Training may be conducted in a supervised, unsupervised, or partially supervised manner. At block 209, the system may evaluate the model according to one or more evaluation criteria. For example, the evaluation may include true positive rates, false positive rates, true negative rates, false negative rates, recall rates (e.g., true positives as a percentage of all actual positives), precision rates (e.g., true positives as a percentage of true and false positives), and so forth. At decision point 210, the system may determine if the model meets the one or more evaluation criteria. If the model fails evaluation, the system may, at block 211, tune the model using the tuning dataset 206, repeating the training block 208 and evaluation block 209 until the model passes the evaluation at decision point 210. Once the model passes the evaluation at decision point 210, the system may exit the model training loop 215. The testing dataset 207 may be run through the trained model 212 and, at block 213, the system may evaluate the results. If the evaluation fails (for example, by having an unacceptable false positive or false negative rate), at decision point 214, the system may reenter training loop 215 for additional training and tuning. If the model passes, the system may stop the training process, resulting in a trained model 212.

In some embodiments, the training process can be different from that depicted in FIG. 2. For example, in some embodiments, the system may not use a testing dataset. In some embodiments, only a single dataset may be used. In some embodiments, two datasets may be used. In some embodiments, the system may use more than three datasets. In some embodiments, the system may use a training dataset and a testing dataset but may not use a tuning dataset. A model can be trained in any suitable manner and is not limited to the process depicted in FIG. 2.

### Binary File Classification

As discussed briefly above, the vector representations of the various sentences may be used for a variety of purposes. One example application of the vector representations is binary file classification. For example, it may be desirable to use the output of the language model to determine whether a given binary file contains malware. In some embodiments, the language model output vectors may be used alone, while in other embodiments, the language model output vectors may provide information about possible execution paths that can be used alongside other information such as binary file structure and header data which may indicate, for example, when the binary file was compiled, which compiler was used, and so forth, for example to determine whether binaries contain malware.

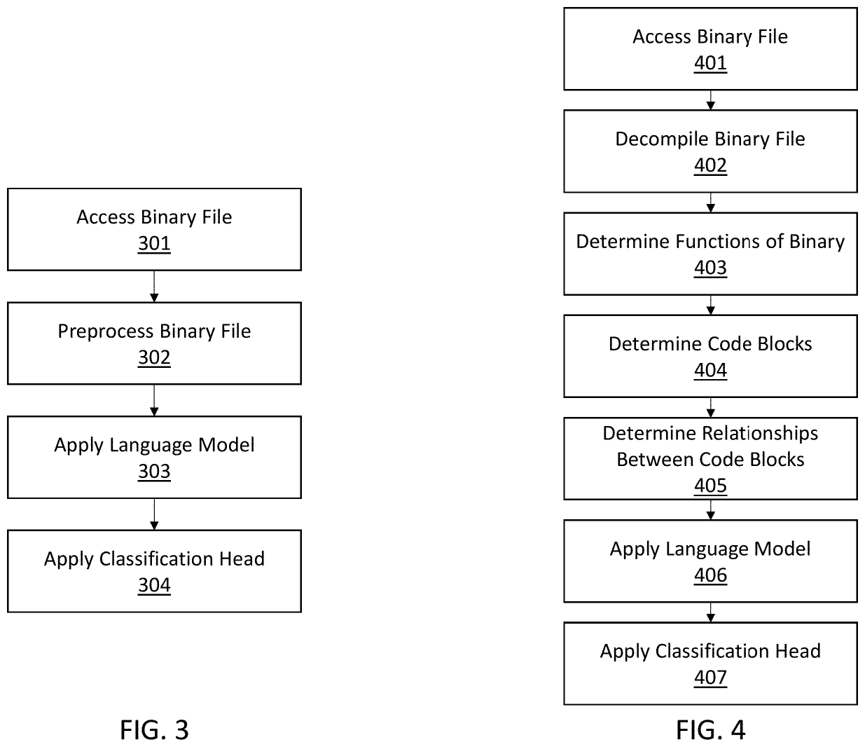

FIG. 3 shows an illustration of an example process for determining whether a binary file contains malware according to some embodiments herein. The process depicted in FIG. 3 may be deployed on a computer system. At 301, the system may access a binary file. At 302, the binary file may be pre-processed. Preprocessing the binary file may comprise, for example, decompiling the binary file into assembly instructions, determining functions in the assembly instructions, determining graphs of the functions, and generating sentences by performing random walks. In some embodiments, the process depicted in FIG. 3 may be performed by the system. In some embodiments, one or more functions of the binary file may be determined by preprocessing the binary file.

At 303, the generated sentences of the binary file may be run through a language model to generate vector representations of the functions in the model. The generated vector representations may, at block 304, be run through a classification head to determine whether the binary file is malicious or not.

FIG. 4 shows an illustration of another example process for determining whether a binary contains malware according to some embodiments herein. At block 401, a system can access a binary file. At block 402, the system can decompile (e.g., disassemble) the binary file. At block 403, the system can analyze the decompiled file to determine functions in the binary. At block 404, the system can determine code blocks within the file. For example, the system can determine code blocks within the functions of the binary file. At block 405, the system can determine relationships between the code blocks, for example determining possible execution paths. The system can generate sentences representing possible execution paths. At block 406, the system can apply a language model to generate vector representations of the sentences. At block 407, the system can run the sentences through a classification head to identify potential malware.

While FIGS. 3 and 4 depict example processes for identifying malware, the processes are not so limited. The same or similar processes can be used for other purposes, such as attribution. For example, instead of or in addition to identify malware, the classification head can be trained to identify binary files that share similarities which can indicate common origin, common type of exploit, etc.

In some embodiments, the classification head may work entirely independently of the language model. For example, the classification head may be independently trained using the vector representations generated by the language model. This approach may be preferable when the language model has been trained on a large dataset and the outputs can effectively serve as a general description of the binary files. In some embodiments, this approach can avoid or limit retraining of the language model, which may be resource-intensive and time-consuming.

In some embodiments, the quality of the classification may be improved by retraining the entire network (for example, the language model and the classification model together) so that the vector representations generated by the language model more specifically relate to whether a sentence is indicative of malicious code. This may be done at least in part by, for example, updating the weights of the language model while training for classification. For example, certain features (e.g., words, patterns, or sequences in sentences) may be strong indicators of malicious software and thus may be given greater weight.

In some embodiments, transfer learning may be used to optimize the network for classification (or for clustering as described below). For example, the system may be configured to construct sentences based on a number of instructions, number of code blocks, and so forth from the entry point of a binary file. In some embodiments, because the model has already been trained on an original, larger dataset, optimizing the model for classification (or clustering) may be less resource intensive and may be achieved with a smaller dataset than the original dataset used to train the model.

### Clustering

Classification systems and methods can be used to assign objects to predefined classes. For example, a binary file can be classified as malicious or not malicious. Classes can be relatively broad (e.g., malicious or not malicious) or relatively narrow (e.g., troj an, rootkit, virus, ransomware).

While classification systems can offer significant insights, a significant limitation is that they are limited to classifying objects into pre-defined categories. This can make it difficult to recognize relationships between different malware. For example, antivirus vendors may have classified a first group of malware as belonging to Group X and a second group of malware as belonging to Group Y. However, some or all of the malware in Group X may be related to the malware in Group Y. For example, some or all malware in Group X could share common code with malware in Group Y. Traditional classification systems and methods can miss such relationships. Moreover, conventional classification systems and methods can use classifications that are relatively broad. This can mean that subgroups with a particular group of malware are not distinguished from one another.

It would be beneficial to have systems and methods for clustering malware (or other binary files) into groups based on commonalities such as shared code, common authorship, common exploits, and so forth. In some embodiments, such an approach can reveal relationships between malware that otherwise may go unnoticed. In some embodiments, clustering can help identify new or emerging threats. Clustering can, in some embodiments, be used to identify relationships between malware that may otherwise have gone unnoticed. For example, one group of malware can be a fork of another group of malware, but the two may differ enough that antivirus and security vendors, unaware of the commonality, have classified them separately.

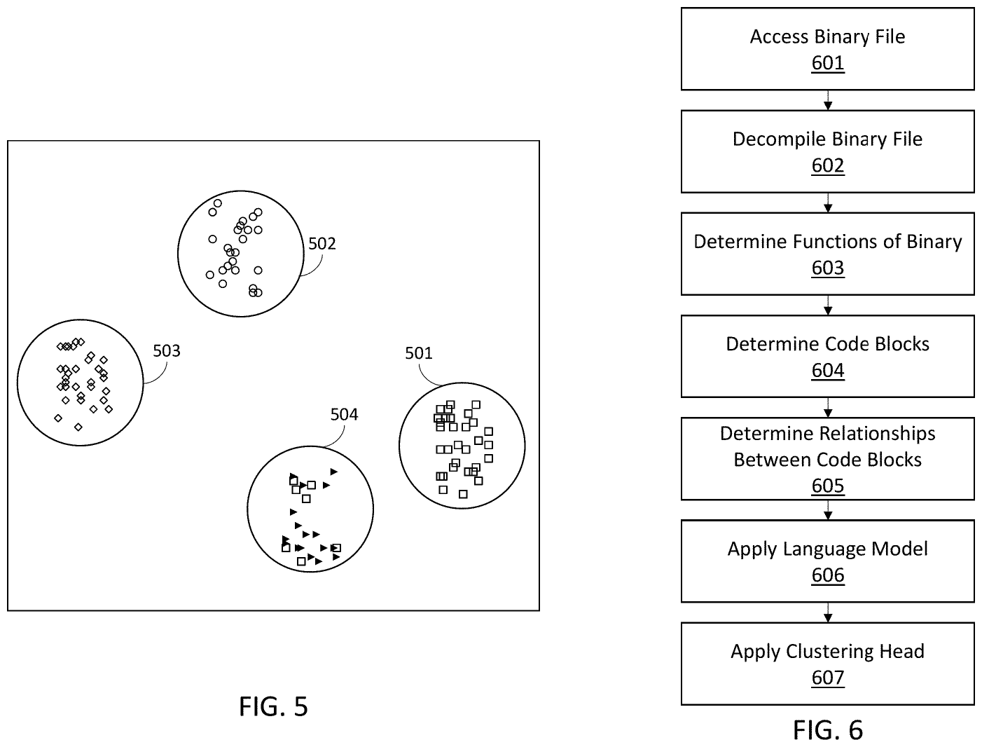

FIG. 5 illustrates an example of clustering according to some embodiments. The shape of each point can indicate a group to which malware has been assigned by antivirus and security vendors, while the large circles indicate clusters identified according to some embodiments herein. In FIG. 5, four clusters of malware 501, 502, 503, and 504 are illustrated. In clusters 501, 502, and 503, each cluster contains malware of a single type as identified by antivirus and security vendors using traditional classification techniques. However, in cluster 504, two different classifications of malware (indicated by solid triangles and open squares) are included. This can indicate, for example, that the two different classifications share common code, common authorship, and so forth. Notably, malware from one classification can appear in more than one cluster. In the illustrative example of FIG. 5, malware in the classification indicated by open squares appears in both cluster 501 and cluster 504. This can indicate, for example, that the two different classifications share some overlap (e.g., code and/or authorship), but other instances of the malware are different enough from that malware indicated by the solid triangles that the two are not necessarily clustered together. For example, the open squares in cluster 504 could be earlier versions that shared more code in common with the malware indicated by solid triangles. Later versions may have dropped or rewritten some or all of the shared code, thus preventing the other malware indicated by open squares from being included in cluster 504 and instead being placed in a different cluster 501.

In some embodiments, the natural language system may be used to determine relationships between different malicious binary files. For example, the system may detect common sentences in different binary files or may detect word or style choices in different malicious files. The system may be configured to identify common origins or common authorship in different binary files, which may aid in attributing a file to a source such as a particular attacker or group. For example, the system may determine that two binary files are related because they share common sentences, indicating that they may use common source code. As another example, the system might determine that two binary files make similar syntactic or stylistic choices, which may indicate that the same person or group of people authored both files.

While the original source code is lost in the compilation process, some evidence of programmer style may remain in compiled code. However, in some cases, the accuracy of identifying common authorship or ancestry may decrease when code is heavily optimized, when custom-made packers are used to compress and hide functionality, or when calls are obfuscated by, for example, directly calling required system calls or dynamically loading functions. For example, when source code is compiled to create an executable, the compiler may make any number of optimizations to improve performance, reduce memory consumption, and so forth. For example, an optimizing compiler may change the order of nested loops, break single loops into multiple loops, eliminate duplicate calculations, discard unused variable assignments (e.g., a value is assigned but is not subsequently used), replace sequences of instructions with other sequences that can perform the same operations, create shared subroutines from multiple different subroutines, combine conditional statements (e.g., “if A then X; if A then Y;” may be combined into “if A then X; Y;”), and so forth. Typically, the person compiling the code can choose an optimization level. For example, during development, a user may choose not to optimize at all in order to minimize compilation times but may optimize later versions (e.g., release versions) to improve the performance of the compiled program. For example, the Clang compiler allows users to choose a variety of optimization levels, with level zero meaning no optimization, level two meaning to optimize without significantly increasing the size of the executable file, and level three meaning to optimize while allowing the size of the executable file to increase. A higher level of optimization may mean that more of the author's original code is changed, causing some of the identifying aspects of the code to be replaced with code that is generated by software during the compilation process.

In some embodiments, a model may be trained to recognize relationships between binary files. For example, a model may be trained using the process depicted in FIG. 2 to identify binary files that show signs of common authorship, common heritage (e.g., malware based on other (e.g., earlier) malware), common vulnerability exploitation, and so forth. A clustering model may give little weight to sentences that are commonly associated with compiler optimizations (although in some cases, particular optimizations may also be used to indicate common authorship such as, for example, if two binary files both use an unusual set of optimizations) and may give greater weight to sentences that are more likely to indicate malware or to indicate relationships between binary files.

A clustering head can be trained in a manner similar to training a classification head. For example, the output of a language model can serve as an input to a clustering head. A dataset can be created that comprises the output of the language model along with annotations which can indicate, for example, shared authorship, shared code, and so forth. The clustering head can be trained to identify common features in the language model output shared by malware or other binaries that share common code, common authorship, and so forth. The clustering head can be trained using any suitable machine learning training process. For example, the clustering head can be trained using the process depicted in FIG. 2.

In some embodiments, a system may use additional information in determining relationships between files. For example, a system may also consider the number of different sections or blocks, the entropy of each section or block, or other features in disassembled code.

FIG. 6 illustrates an example process for clustering a binary file according to some embodiments. At block 601, a system can access a binary file. At block 602, the system can decompile or disassemble the binary file. At block 603, the system can determine functions included in the binary file. At block 604, the system can determine code blocks within the binary file. At block 605, the system can determine relationships between the code blocks within the binary file, for example to generate a directed graph indicative of possible execution paths. The system can generate sentences that correspond to random walks of the directed graph. At block 606, a natural language model can generate feature vectors from the sentences. The feature vectors can be fed into a clustering head at block 607.

### Computer Systems

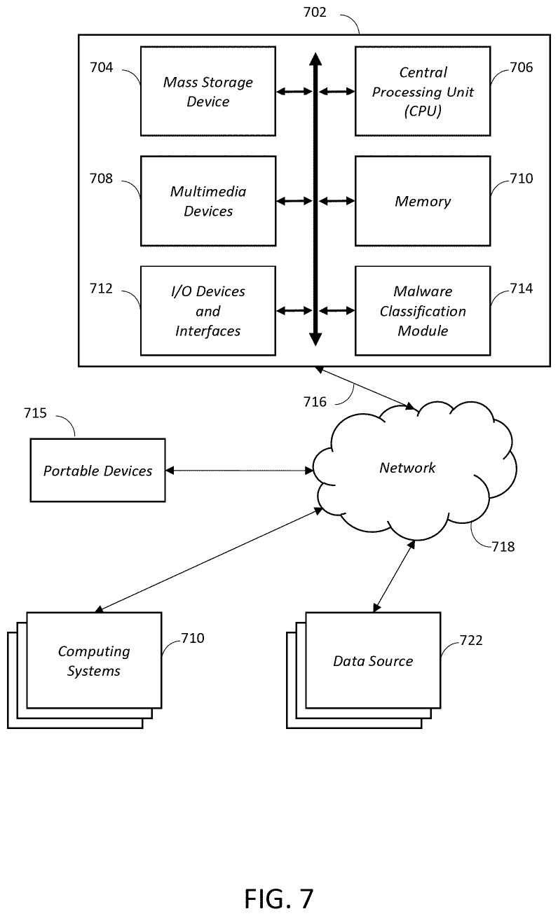

FIG. 7 is a block diagram depicting an embodiment of a computer hardware system configured to run software for implementing one or more embodiments disclosed herein.

In some embodiments, the systems, processes, and methods described herein are implemented using a computing system, such as the one illustrated in FIG. 7. The example computer system 702 is in communication with one or more computing systems 720 and/or one or more data sources 722 via one or more networks 718. While FIG. 7 illustrates an embodiment of a computing system 702, it is recognized that the functionality provided for in the components and modules of computer system 702 may be combined into fewer components and modules, or further separated into additional components and modules.

The computer system 702 can comprise a module 714 that carries out the functions, methods, acts, and/or processes described herein. The module 714 is executed on the computer system 702 by a central processing unit 706 discussed further below.

In general, the word “module,” as used herein, refers to logic embodied in hardware or firmware or to a collection of software instructions, having entry and exit points. Modules are written in a program language, such as JAVA, C or C++, Python, or the like. Software modules may be compiled or linked into an executable program, installed in a dynamic link library, or may be written in an interpreted language such as BASIC, PERL, LUA, or Python. Software modules may be called from other modules or from themselves, and/or may be invoked in response to detected events or interruptions. Modules implemented in hardware include connected logic units such as gates and flip-flops, and/or may include programmable units, such as programmable gate arrays or processors.

Generally, the modules described herein refer to logical modules that may be combined with other modules or divided into sub-modules despite their physical organization or storage. The modules are executed by one or more computing systems and may be stored on or within any suitable computer readable medium or implemented in-whole or in-part within special designed hardware or firmware. Not all calculations, analysis, and/or optimization require the use of computer systems, though any of the above-described methods, calculations, processes, or analyses may be facilitated through the use of computers. Further, in some embodiments, process blocks described herein may be altered, rearranged, combined, and/or omitted.

The computer system 702 includes one or more processing units (CPU) 706, which may comprise a microprocessor. The computer system 702 further includes a physical memory 710, such as random-access memory (RAM) for temporary storage of information, a read only memory (ROM) for permanent storage of information, and a mass storage device 704, such as a backing store, hard drive, rotating magnetic disks, solid state disks (SSD), flash memory, phase-change memory (PCM), 3D XPoint memory, diskette, or optical media storage device. Alternatively, the mass storage device may be implemented in an array of servers. Typically, the components of the computer system 702 are connected to the computer using a standards-based bus system. The bus system can be implemented using various protocols, such as Peripheral Component Interconnect (PCI), Micro Channel, SCSI, Industrial Standard Architecture (ISA) and Extended ISA (EISA) architectures.

The computer system 702 includes one or more input/output (I/O) devices and interfaces 712, such as a keyboard, mouse, touch pad, and printer. The I/O devices and interfaces 712 can include one or more display devices, such as a monitor, that allows the visual presentation of data to a user. More particularly, a display device provides for the presentation of GUIs as application software data, and multi-media presentations, for example. The I/O devices and interfaces 712 can also provide a communications interface to various external devices. The computer system 702 may comprise one or more multi-media devices 708, such as speakers, video cards, graphics accelerators, and microphones, for example.

The computer system 702 may run on a variety of computing devices, such as a server, a Windows server, a Structure Query Language server, a Unix Server, a personal computer, a laptop computer, and so forth. In other embodiments, the computer system 702 may run on a cluster computer system, a mainframe computer system and/or other computing system suitable for controlling and/or communicating with large databases, performing high volume transaction processing, and generating reports from large databases. The computing system 702 is generally controlled and coordinated by an operating system software, such as Windows XP, Windows Vista, Windows 7, Windows 8, Windows 10, Windows 11, Windows Server, Unix, Linux (and its variants such as Debian, Linux Mint, Fedora, and Red Hat), SunOS, Solaris, Blackberry OS, z/OS, iOS, macOS, or other operating systems, including proprietary operating systems. Operating systems control and schedule computer processes for execution, perform memory management, provide file system, networking, and I/O services, and provide a user interface, such as a graphical user interface (GUI), among other things.

The computer system 702 illustrated in FIG. 7 is coupled to a network 718, such as a LAN, WAN, or the Internet via a communication link 716 (wired, wireless, or a combination thereof). Network 718 communicates with various computing devices and/or other electronic devices. Network 718 is communicating with one or more computing systems 720 and one or more data sources 722. The module 714 may access or may be accessed by computing systems 720 and/or data sources 722 through a web-enabled user access point. Connections may be a direct physical connection, a virtual connection, and other connection type. The web-enabled user access point may comprise a browser module that uses text, graphics, audio, video, and other media to present data and to allow interaction with data via the network 718.

Access to the module 714 of the computer system 702 by computing systems 720 and/or by data sources 722 may be through a web-enabled user access point such as the computing systems' 720 or data source's 722 personal computer, cellular phone, smartphone, laptop, tablet computer, e-reader device, audio player, or another device capable of connecting to the network 718. Such a device may have a browser module that is implemented as a module that uses text, graphics, audio, video, and other media to present data and to allow interaction with data via the network 718.

The output module may be implemented as a combination of an all-points addressable display such as a cathode ray tube (CRT), a liquid crystal display (LCD), a plasma display, or other types and/or combinations of displays. The output module may be implemented to communicate with input devices 712 and they also include software with the appropriate interfaces which allow a user to access data through the use of stylized screen elements, such as menus, windows, dialogue boxes, tool bars, and controls (for example, radio buttons, check boxes, sliding scales, and so forth). Furthermore, the output module may communicate with a set of input and output devices to receive signals from the user.

The input device(s) may comprise a keyboard, roller ball, pen and stylus, mouse, trackball, voice recognition system, or pre-designated switches or buttons. The output device(s) may comprise a speaker, a display screen, a printer, or a voice synthesizer. In addition, a touch screen may act as a hybrid input/output device. In another embodiment, a user may interact with the system more directly such as through a system terminal connected to the score generator without communications over the Internet, a WAN, or LAN, or similar network.

In some embodiments, the system 702 may comprise a physical or logical connection established between a remote microprocessor and a mainframe host computer for the express purpose of uploading, downloading, or viewing interactive data and databases online in real time. The remote microprocessor may be operated by an entity operating the computer system 702, including the client server systems or the main server system, an/or may be operated by one or more of the data sources 722 and/or one or more of the computing systems 720. In some embodiments, terminal emulation software may be used on the microprocessor for participating in the micro-mainframe link.

In some embodiments, computing systems 720 who are internal to an entity operating the computer system 702 may access the module 714 internally as an application or process run by the CPU 706.

In some embodiments, one or more features of the systems, methods, and devices described herein can utilize a URL and/or cookies, for example for storing and/or transmitting data or user information. A Uniform Resource Locator (URL) can include a web address and/or a reference to a web resource that is stored on a database and/or a server. The URL can specify the location of the resource on a computer and/or a computer network. The URL can include a mechanism to retrieve the network resource. The source of the network resource can receive a URL, identify the location of the web resource, and transmit the web resource back to the requestor. A URL can be converted to an IP address, and a Domain Name System (DNS) can look up the URL and its corresponding IP address. URLs can be references to web pages, file transfers, emails, database accesses, and other applications. The URLs can include a sequence of characters that identify a path, domain name, a file extension, a host name, a query, a fragment, scheme, a protocol identifier, a port number, a username, a password, a flag, an object, a resource name and/or the like. The systems disclosed herein can generate, receive, transmit, apply, parse, serialize, render, and/or perform an action on a URL.

A cookie, also referred to as an HTTP cookie, a web cookie, an internet cookie, and a browser cookie, can include data sent from a web site and/or stored on a user's computer. This data can be stored by a user's web browser while the user is browsing. The cookies can include useful information for websites to remember prior browsing information, such as a shopping cart on an online store, clicking of buttons, login information, and/or records of web pages or network resources visited in the past. Cookies can also include information that the user enters, such as names, addresses, passwords, credit card information, etc. Cookies can also perform computer functions. For example, authentication cookies can be used by applications (for example, a web browser) to identify whether the user is already logged in (for example, to a web site). The cookie data can be encrypted to provide security for the consumer. Tracking cookies can be used to compile historical browsing histories of individuals. Systems disclosed herein can generate and use cookies to access data of an individual. Systems can also generate and use JSON web tokens to store authenticity information, HTTP authentication as authentication protocols, IP addresses to track session or identity information, URLs, and the like.

The computing system 702 may include one or more internal and/or external data sources (for example, data sources 722). In some embodiments, one or more of the data repositories and the data sources described above may be implemented using a relational database, such as Sybase, Oracle, CodeBase, DB2, PostgreSQL, and Microsoft® SQL Server as well as other types of databases such as, for example, a NoSQL database (for example, Couchbase, Cassandra, or MongoDB), a flat file database, an entity-relationship database, an object-oriented database (for example, InterSystems Cache), a cloud-based database (for example, Amazon RDS, Azure SQL, Microsoft Cosmos DB, Azure Database for MySQL, Azure Database for MariaDB, Azure Cache for Redis, Azure Managed Instance for Apache Cassandra, Google Bare Metal Solution for Oracle on Google Cloud, Google Cloud SQL, Google Cloud Spanner, Google Cloud Big Table, Google Firestore, Google Firebase Realtime Database, Google Memorystore, Google MongoDB Atlas, Amazon Aurora, Amazon DynamoDB, Amazon Redshift, Amazon ElastiCache, Amazon MemoryDB for Redis, Amazon DocumentDB, Amazon Keyspaces, Amazon Neptune, Amazon Timestream, or Amazon QLDB), a non-relational database, or a record-based database.

The computer system 702 may also access one or more databases 722. The databases 722 may be stored in a database or data repository. The computer system 702 may access the one or more databases 722 through a network 718 or may directly access the database or data repository through I/O devices and interfaces 712. The data repository storing the one or more databases 722 may reside within the computer system 702.

### Additional Embodiments

In the foregoing specification, the systems and processes have been described with reference to specific embodiments thereof. It will, however, be evident that various modifications and changes may be made thereto without departing from the broader spirit and scope of the embodiments disclosed herein. The specification and drawings are, accordingly, to be regarded in an illustrative rather than restrictive sense.

Indeed, although the systems and processes have been disclosed in the context of certain embodiments and examples, it will be understood by those skilled in the art that the various embodiments of the systems and processes extend beyond the specifically disclosed embodiments to other alternative embodiments and/or uses of the systems and processes and obvious modifications and equivalents thereof. In addition, while several variations of the embodiments of the systems and processes have been shown and described in detail, other modifications, which are within the scope of this disclosure, will be readily apparent to those of skill in the art based upon this disclosure. It is also contemplated that various combinations or sub-combinations of the specific features and aspects of the embodiments may be made and still fall within the scope of the disclosure. It should be understood that various features and aspects of the disclosed embodiments can be combined with, or substituted for, one another in order to form varying modes of the embodiments of the disclosed systems and processes. Any methods disclosed herein need not be performed in the order recited. Thus, it is intended that the scope of the systems and processes herein disclosed should not be limited by the particular embodiments described above.

It will be appreciated that the systems and methods of the disclosure each have several innovative aspects, no single one of which is solely responsible or required for the desirable attributes disclosed herein. The various features and processes described above may be used independently of one another or may be combined in various ways. All possible combinations and sub-combinations are intended to fall within the scope of this disclosure.

Certain features that are described in this specification in the context of separate embodiments also may be implemented in combination in a single embodiment. Conversely, various features that are described in the context of a single embodiment also may be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination. No single feature or group of features is necessary or indispensable to each and every embodiment.

It will also be appreciated that conditional language used herein, such as, among others, “can,” “could,” “might,” “may,” “for example,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. In addition, the term “or” is used in its inclusive sense (and not in its exclusive sense) so that when used, for example, to connect a list of elements, the term “or” means one, some, or all of the elements in the list. In addition, the articles “a,” “an,” and “the” as used in this application and the appended claims are to be construed to mean “one or more” or “at least one” unless specified otherwise. Similarly, while operations may be depicted in the drawings in a particular order, it is to be recognized that such operations need not be performed in the particular order shown or in sequential order, or that all illustrated operations be performed, to achieve desirable results. Further, the drawings may schematically depict one or more example processes in the form of a flowchart. However, other operations that are not depicted may be incorporated in the example methods and processes that are schematically illustrated. For example, one or more additional operations may be performed before, after, simultaneously, or between any of the illustrated operations. Additionally, the operations may be rearranged or reordered in other embodiments. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products. Additionally, other embodiments are within the scope of the following claims. In some cases, the actions recited in the claims may be performed in a different order and still achieve desirable results.

Further, while the methods and devices described herein may be susceptible to various modifications and alternative forms, specific examples thereof have been shown in the drawings and are herein described in detail. It should be understood, however, that the embodiments are not to be limited to the particular forms or methods disclosed, but, to the contrary, the embodiments are to cover all modifications, equivalents, and alternatives falling within the spirit and scope of the various implementations described and the appended claims. Further, the disclosure herein of any particular feature, aspect, method, property, characteristic, quality, attribute, element, or the like in connection with an implementation or embodiment can be used in all other implementations or embodiments set forth herein. Any methods disclosed herein need not be performed in the order recited. The methods disclosed herein may include certain actions taken by a practitioner; however, the methods can also include any third-party instruction of those actions, either expressly or by implication. The ranges disclosed herein also encompass any and all overlap, sub-ranges, and combinations thereof. Language such as “up to,” “at least,” “greater than,” “less than,” “between,” and the like includes the number recited. Numbers preceded by a term such as “about” or “approximately” include the recited numbers and should be interpreted based on the circumstances (for example, as accurate as reasonably possible under the circumstances, for example ±5%, ±10%, ±15%, etc.). For example, “about 3.5 mm” includes “3.5 mm.” Phrases preceded by a term such as “substantially” include the recited phrase and should be interpreted based on the circumstances (for example, as much as reasonably possible under the circumstances). For example, “substantially constant” includes “constant.” Unless stated otherwise, all measurements are at standard conditions including temperature and pressure.

As used herein, a phrase referring to “at least one of” a list of items refers to any combination of those items, including single members. As an example, “at least one of: A, B, or C” is intended to cover: A, B, C, A and B, A and C, B and C, and A, B, and C. Conjunctive language such as the phrase “at least one of X, Y and Z,” unless specifically stated otherwise, is otherwise understood with the context as used in general to convey that an item, term, etc. may be at least one of X, Y or Z. Thus, such conjunctive language is not generally intended to imply that certain embodiments require at least one of X, at least one of Y, and at least one of Z to each be present. The headings provided herein, if any, are for convenience only and do not necessarily affect the scope or meaning of the devices and methods disclosed herein.

Accordingly, the claims are not intended to be limited to the embodiments shown herein but are to be accorded the widest scope consistent with this disclosure, the principles and the novel features disclosed herein.

What is claimed is:

1. A computer-implemented method for binary file analysis comprising:
receiving, by a computer system, a binary file, wherein the binary file comprises executable code;
generating, by the computer system using a decompiler, assembly code from the binary file, wherein the assembly code comprises a sequence of instructions that can be executed on an other computing system;
identifying, by the computer system using one or more heuristics, one or more functions in the assembly code, wherein each function of the one or more functions comprises one or more instructions;
identifying, by the computer system, one or more blocks within the one or more functions in the assembly code, wherein each block of the one or more blocks comprises one or more instructions;
generating, by the computer system, a directed graph, wherein the directed graph comprises possible execution paths through the one or more blocks;
determining, by the computer system using the directed graph, one or more execution paths through the one or more code blocks, wherein determining the one or more execution paths comprises performing a random walk through the directed graph;
generating, by the computer system, one or more sentences representing the one or more execution paths through the one or more code blocks;
determining, by the computing system using a language model, a vector representation for each sentence of the one or more sentences,
wherein the computer system comprises a processor and memory.

2. The method of claim 1, further comprising:
determining, by the computing system using vector representations, a classification of the binary file, wherein the classification indicates that the file is malicious or that the file is not malicious.

3. The method of claim 1, wherein generating the one or more sentences comprises:
determining that a sentence of the one or more sentence is the same as another sentence of the one or more sentences; and
deleting the sentence.

4. The method of claim 1, wherein generating the one or more sentences comprises:
determining that a sentence comprises a sequence of adjacent instructions, wherein each instruction in the sequence of adjacent instructions is the same; and
removing repeated instructions from the sequence of adjacent instructions.

5. The method of claim 1, wherein identifying one or more functions in the assembly code comprises identifying a stack frame.

6. The method of claim 1, wherein identifying the one or more functions in the assembly code comprises determining a target address of a call instruction.

7. The method of claim 1, wherein identifying the one or more code blocks comprises identifying a branching instruction.

8. The method of claim 7, wherein the branching instruction comprises a jump instruction.

9. The method of claim 1, wherein identifying the one or more code blocks comprises identifying an address of a call instruction.

10. The method of claim 1, further comprising:
determining, by the computing system using the vector representation, a clustering of the binary file, wherein the clustering indicates a similarity of the binary file to a second binary file.

11. A computing system comprising for binary file analysis comprising:
a non-transitory computer-readable storage medium with instructions encoded thereon; and
one or more processors,
wherein the instructions, when executed by the one or more processors, cause the computing system to:
receive a binary file, wherein the binary file comprises executable code;
generate, using a decompiler, assembly code from the binary file, wherein the assembly code comprises a sequence of instructions that can be executed on an other computing system;
identify, using one or more heuristics, one or more functions in the assembly code, wherein each function of the one or more functions comprises one or more instructions;
identify one or more blocks within the one or more functions in the assembly code, wherein each block of the one or more blocks comprises one or more instructions;
generate a directed graph, wherein the directed graph comprises possible execution paths through the one or more blocks;
determine, using the directed graph, one or more execution paths through the one or more code blocks, wherein determining the one or more execution paths comprises performing a random walk through the directed graph;
generate one or more sentences representing the one or more execution paths through the one or more code blocks;
determine, using a language model, a vector representation for each sentence of the one or more sentences.

12. The computing system of claim 11, wherein the instructions are further configured to cause the computing system to:
determine, using vector representations, a classification of the binary file, wherein the classification indicates that the file is malicious or that the file is not malicious.

13. The computing system of claim 11, wherein to generate the one or more sentences, the instructions are configured to cause the computing system to:
determine that a sentence of the one or more sentence is the same as another sentence of the one or more sentences; and
delete the sentence.

14. The computing system of claim 11, wherein to generate the one or more sentences, the instructions are configured to cause the computing system to:
determine that a sentence comprises a sequence of adjacent instructions, wherein each instruction in the sequence of adjacent instructions is the same; and
remove repeated instructions from the sequence of adjacent instructions.

15. The computing system of claim 11, wherein to identify one or more functions in the assembly code, the instructions are configured to cause the computing system to identify a stack frame.

16. The computing system of claim 11, wherein to identify the one or more functions in the assembly code, the instructions are configured to cause the computing system to determine a target address of a call instruction.

17. The computing system of claim 11, wherein to identify the one or more code blocks, the instructions are configured to cause the computing system to identify a branching instruction.

18. The computing system of claim 17, wherein the branching instruction comprises a jump instruction.

19. The computing system of claim 11, wherein to identify the one or more code blocks, the instructions are configured to cause the computing system to identify an address of a call instruction.

20. The computing system of claim 11, wherein the instructions are further configured to cause the computing system to:
determine, using the vector representation, a clustering of the binary file, wherein the clustering indicates a similarity of the binary file to a second binary file.
